(19) United States
(12) Patent Application Publication
(10) Pub. No.: US 2022/0058479 A1
(43) Pub. Date: Feb. 24, 2022

(54) METHOD OF JUDGING RELIABILITY OF DEEP LEARNING MACHINE

(71) Applicant: Cloudbric Corp, Seoul (KR)

(72) Inventors: Seung Young Park, Chuncheon-si (KR); Tai Yun Kim, Seoul (KR); Tae Joon Jung, Hanam-si (KR); Duk Soo Kim, Seoul (KR)

(73) Assignee: Cloudbric Corp, Seoul (KR)

(21) Appl. No.: 17/067,753

(22) Filed: Oct. 11, 2020

(30) Foreign Application Priority Data
Aug. 24, 2020 (KR) 10-2020-0106630

(51) Int. Cl. G06N 3/08; G06N 3/04

(52) U.S. Cl. CPC G06N 3/08; G06N 3/04

(57) ABSTRACT

A method of judging reliability of a deep learning machine, includes: temporarily judging a class of data to be judged; checking an attack/normal ratio of temporarily judged data, configuring N mini-batches by using M test data that have been judged whether it is normal or attack data, and configuring T mini-batch sets each including the N mini-batches; and iteratively performing multiple times a process of judging the test data provided for each of the N mini-batches configuring the mini-batch sets to judge an attack/normal ratio of each of the N mini-batches, wherein the M test data that are used for each of the T mini-batch sets are the same but combinations of the test data of each of the mini-batches are different for each of the mini-batches and a size of each of the mini-batches is M/N.

### CROSS-REFERENCE TO RELATED APPLICATIONS

This application is based upon and claims the benefit of priority from prior Korean patent application No. 10-2020-0106630 filed on Aug. 24, 2020, the entire contents of which are incorporated herein by reference.

### TECHNICAL FIELD

The present invention relates to a method of judging reliability of a deep learning machine.

### BACKGROUND ART

The deep learning is technology that enables a machine to learn specific types of data and to recognize, reason and judge by itself, like humans. For example, the deep learning is technology that enables a machine to learn tens of thousands of pictures so that the machine can recognize by itself what a new picture is.

In order to use a deep learning machine to which the deep learning is applied, it is necessary to confirm reliability of the deep learning machine. To this end, processes of judging the reliability of the deep learning machine should be performed.

However, in order to judge the reliability of the deep learning machine, a large amount of computation is required in the related art. Therefore, many tests and periods are required before the deep learning machine is actually used.

### CITATION LIST

### Patent Literature

(PTL 1) Korean Patent No. 10-2107847: Deep learning method in which hexadecimal image conversion and incremental learning for web traffic learning are applied

### SUMMARY OF DISCLOSURE

The invention has been made in view of the above situations, and an object thereof is to provide a method of judging reliability of a deep learning machine capable of reducing an amount of computation when judging test data.

In order to achieve the above technical object, a method of judging reliability of a deep learning machine in accordance with the present invention includes temporarily judging a class of data to be judged; checking an attack/normal ratio of temporarily judged data, configuring N mini-batches by using M test data that have been judged whether it is normal or attack data, and configuring T mini-batch sets each including the N mini-batches; and iteratively performing multiple times (preferably, T times) a process of judging the test data provided for each of the N mini-batches configuring the mini-batch sets to judge an attack/normal ratio of each of the N mini-batches, wherein the M test data that are used for each of the T mini-batch sets are the same but combinations of the test data of each of the mini-batches are different for each of the mini-batches and a size of each of the mini-batches is M/N.

According to the present invention, as compared to the conventional method of judging reliability of a deep learning machine, the judgment reliability can be improved. Also, the reliability of a deep learning machine can be judged in a significantly smaller amount of computation than the conventional MCBN.

### BRIEF DESCRIPTION OF DRAWINGS

FIG. 1 exemplifies a deep learning system to which a method of judging reliability of a deep learning machine in accordance with the present invention is applied.

FIG. 2 exemplifies a configuration of a deep learning machine that is applied to the present invention.

FIG. 3 exemplifies a method of judging reliability of a deep learning machine in accordance with the related art.

FIG. 4 exemplifies a method of judging reliability of a deep learning machine using an MCBN method of the related art.

FIG. 5 exemplifies a method of judging reliability of a deep learning machine in accordance with the present invention.

### DESCRIPTION OF EMBODIMENTS

Hereinbelow, an embodiment of the present invention will be described in detail with reference to the accompanying drawings.

The present invention relates to a method of judging reliability of a deep learning machine configured to perform deep learning by using the method disclosed in Korean Patent No. 10-2107847 (hereinbelow, simply referred to as the registered patent) or a variety of currently known methods.

Therefore, the deep learning machine that is applied to the present invention is configured to perform the deep learning by using the deep learning technique.

That is, the present invention relates to a method of judging reliability of a deep learning machine having performed the deep learning.

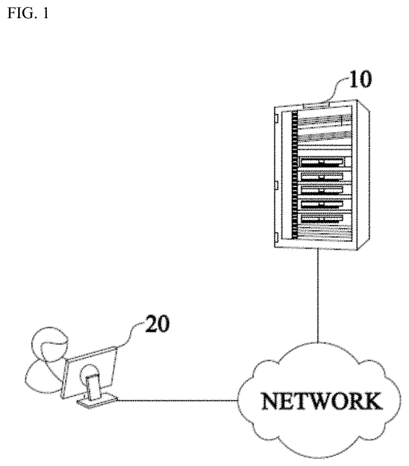

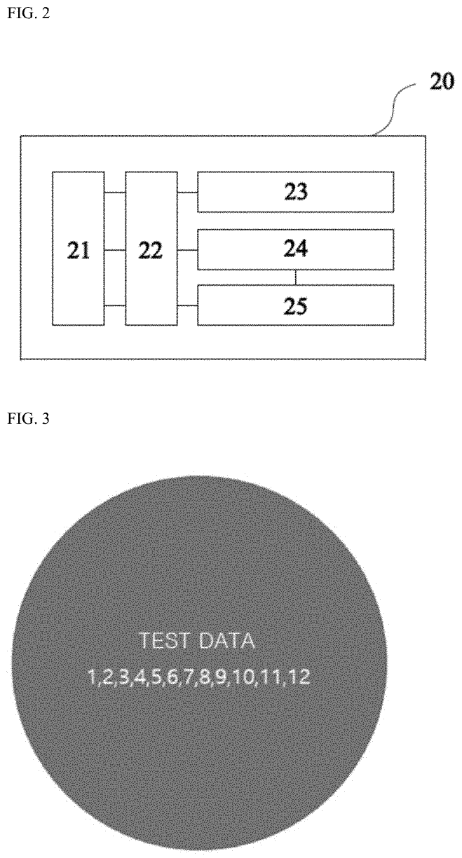

FIG. 1 exemplifies a deep learning system to which a method of judging reliability of a deep learning machine in accordance with the present invention is applied, and FIG. 2 exemplifies a configuration of a deep learning machine that is applied to the present invention.

As shown in FIG. 1, the deep learning system to which the present invention is applied includes a deep learning machine 20 configured to use the deep learning technique and a server 10 that is used for the deep learning machine to perform the deep learning.

As shown in FIG. 2, the deep learning machine 20 includes a communication unit 21 configured to perform communication with external devices via a network, an input 23 configured to receive a variety of information from a user, an output unit 24 configured to output a variety of information, a storage unit 25 configured to store a variety of information, and a control unit 22 configured to control functions of the constitutional elements.

The deep learning machine 20 may be a server that is generally currently used, a personal computer (PC) or a variety of electronic devices such as a tablet PC and a smartphone.

The deep learning machine 20 is configured to learn the deep learning technique by using a variety of methods disclosed in the registered patent and the like. In this case, the deep learning machine 20 can learn the deep learning technique by a variety of training data that are provided by the server 10. Also, the deep learning machine 20 can fetch the training data from the server 10. In particular, the deep learning machine 20 can also perform the method of judging reliability of a deep learning machine in accordance with the present invention.

The method of judging reliability of a deep learning machine in accordance with the present invention can also be performed by the deep learning machine 20 and the server 10. For example, the deep learning machine 20 can perform a function of judging whether the test data is attack or normal data, and the server 10 can perform functions of setting mini-batch sets to be described later and judging reliability of the deep learning machine by using an average resulting from the judgment in the deep learning machine 20.

In the below, a conventional method of judging reliability of a deep learning machine, a method of judging reliability of a deep learning machine using a conventional MCBN method and a method of judging reliability of a deep learning machine in accordance with the present invention are described.

First, a conventional method of judging reliability of a deep learning machine for HTTP traffic is described.

When the deep learning machine performs learning and then judges reliability thereof, the deep learning machine performs only once the judgment with a mini-batch consisting of test data.

When performing a test, a parameter of a batch normalization layer of the learned deep learning machine is fixed, and dropout is inactivated.

Since the same test data are tested by the deep learning machine of the same structure, even though the deep learning machine iteratively judges the same test data, a judgment probability value is bound to be the same every time, and the corresponding value is generally close to 1.

That is, even when the judgment is wrong, since the judgment probability value is mostly close to 1, it is not possible to know how reliable the judgment is. Ideally, in order to trust the deep learning machine, the judgment probability should be close to ½ for data for which a judgment error occurs, and the judgment probability should be close to 1 for data for which the judgment is correctly made.

Second, a method of judging reliability of a deep learning machine using a conventional MCBN method is described.

In order to solve the above-described problems, the MCBN (Monte Carlo Batch Normalization) technique is applied in the related art.

After the deep learning machine using the MCBN technique performs learning, one test data to be judged and the other data used for learning (hereinbelow, referred to as training data) are randomly selected to configure mini-batches, so that the deep learning machine iteratively judges the mini-batches.

When configuring the mini-batches for iterative judgment for judgment data, the training data used for learning is again randomly selected. Also, an attack/normal ratio of the training data configuring the mini-batches should be made to coincide with an attack/normal ratio in the training process.

Usually, in the training process, a balance between labels is maintained at 1:1 through oversampling so as to balance the judgment accuracy between labels.

That is, when data to be judged is provided, the deep learning machine performs iterative judgment. At this time, all data except judgment data (test data) are randomly selected from the existing training data and the configuration thereof is changed every judgment.

Also, during the judgment, a batch normalization layer and a dropout layer configuring a learned machine are activated.

All training data except judgment data (test data) are changed every judgment, which affects the batch normalization layer.

According to the deep learning machine using the MCBN technique, the judgment probability changes every judgment. When the judgment probabilities are averaged, an average is expected to converge on an actual judgment probability value. Therefore, it is possible to obtain more reliable reliability than the conventional reliability.

Third, a method of judging reliability of a deep learning machine in accordance with the present invention is described.

An object of the present invention is first described.

An object of the present invention is to accurately show how reliable a result value for data judged by the deep learning machine 20 is.

Also, according to the conventional MCBN, for judgment of single test data, since the mini-batches are configured using the training data for which it is not necessary to perform judgment, a too large amount of computation is required. Therefore, the present invention is to reduce the amount of computation necessary for reliability judgment.

A configuration of the present invention is described.

After the deep learning machine 20 performs training, it is necessary to check an attack/normal ratio of the trained data.

A class is temporarily judged by running once the test data on a deep learning machine learned by the conventional method.

The attack/normal ratio of the temporarily judged data is checked, and a data set ratio between each class is adjusted to the attack/normal ratio of the trained data through oversampling from the training data for classes consisting of a small amount of data. Usually, the attack/normal ratio is substantially adjusted to 1:1.

When performing judgment by using data whose attack/normal ratio is adjusted, the mini-batches consisting of the test data are tested multiple times. At this time, although there may be a judgment error due to the machine learned by the existing method, since most of the mini-batches consist of test data with no judgment error, the attack/normal ratio of the test data configuring the mini-batches may be substantially similar to the ratio in the training process.

When performing the test process, the configuration of the mini-batch is changed every one test, and the batch normalization layer and dropout layer of the learned machine are changed every time.

Since the same test data are tested every time in a deep learning machine of a different structure, a deviation of the judgment probability value may occur. The judgment probability value is different every time, so that the reliability may also be evenly distributed.

That is, the reliability of the judgment probability value may be more reliable.

The effects of the present invention are described.

According to the present invention, while securing the higher judgment reliability than that of the deep learning machine of the related art, the amount of computation that is used in the present invention is smaller than that of the MCBN.

Subsequently, the terms that are used in descriptions below are described.

The judgment probability value refers to a reliability score, i.e., judgment accuracy.

The judgment reliability refers to an average of one time, and particularly, when it is judged as to attack/normal, the judgment reliability refers to how reliable the judgment is.

Therefore, the closer the average probability is to 1, the more reliable the corresponding judgment is, and the closer the average probability is to 0.5, the less reliable the corresponding judgment is,

The judgment class is classified into attack or normal.

The mini-batch refers to a group made by dividing data to be judged. For example, when 100 data are divided by 5, 20 mini-batches are generated.

Batch normalization means calculating an average value of results for differently configured mini-batch sets, whenever a test is performed.

Dropout means solving an overfitting problem by simplifying a neutral network structure of a deep learning machine.

Accuracy refers to a value obtained by dividing the number matching the actual class by the total number of judgments.

F1 score means a harmonic average of precision and re-call.

The judgment error data refers to data that is judged opposite to the actual class.

For classes consisting of a small amount of data, adjusting the data set ratio between each class to 1:1 through oversampling from the training data means as follows. That is, if data to be tested are randomly run on an existing trained machine, the data are divided into two classes of attack and normal. If the number of attacks is smaller than that of normal traffic, more attack data are fetched from the training data to adjust the numbers of attack and normal of the test data to a ratio of 1:1.

In the below, the reliability judging method of the related art and the method of judging reliability of a deep learning machine in accordance with the present invention are described with reference to an actual example.

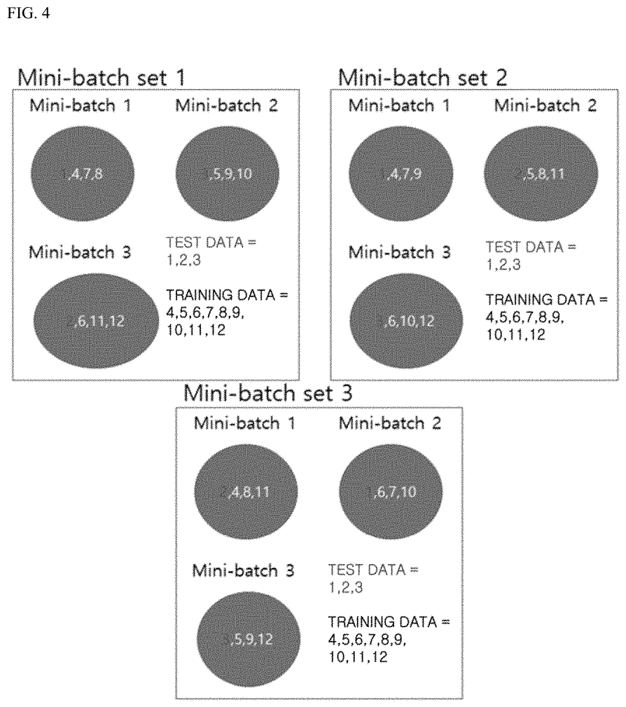

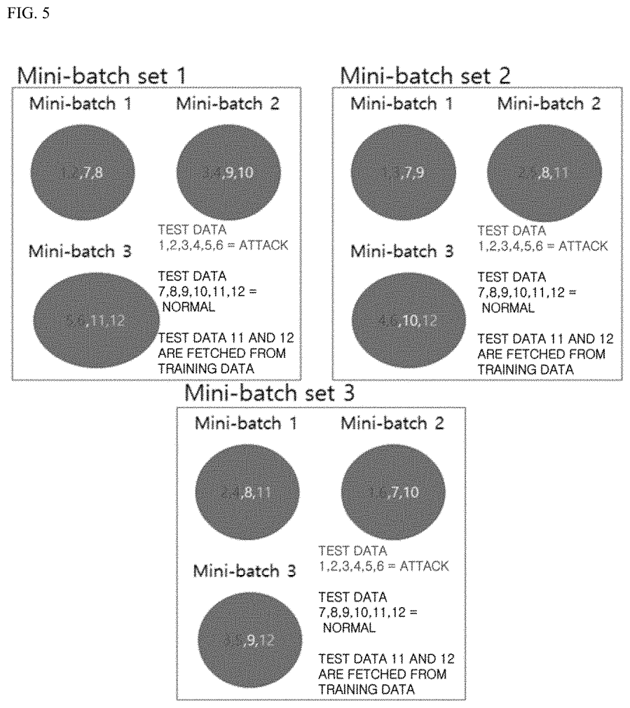

FIG. 3 exemplifies a method of judging reliability of a deep learning machine in accordance with the related art, FIG. 4 exemplifies a method of judging reliability of a deep learning machine using an MCBN method of the related art, and FIG. 5 exemplifies a method of judging reliability of a deep learning machine in accordance with the present invention.

After the deep learning machine 20 performs learning, when it is confirmed whether the deep learning machine 20 can be normally driven, the deep learning machine 20 can be substantially used by a user.

First, the method of judging reliability of a deep learning machine of the related art is described with reference to FIG. 3.

The test data are first judged by using the deep learning machine 20.

While the dropout layer and the batch normalization layer are activated in the training process, the dropout layer and the batch normalization layer are inactivated in the test process. Thereby, the same judgment result is obtained all the time. That is, when the method of judging reliability of a deep learning machine of the related art is used, it is meaningless to perform the test more than once.

The method of judging reliability of a deep learning machine of the related art has a problem that since a probability value of an erroneous judgment is always the same, it is difficult to confirm the accuracy or reliability of the judgment.

Next, the method of judging reliability of a deep learning machine using an MCBN method of the related art is described with reference to FIG. 4.

FIG. 4 shows a process of judging judgment data, i.e., three test data by using mini-batches whose size is 4 (four).

Each of the mini-batches consists of one test data and three training data, and the deep learning machine iteratively performs judgment three times.

During the training, the attack and normal ratio is adjusted to 1:1 through oversampling of the training data. Therefore, the attack and normal ratio in the mini-batches that are used in the judgment process should also be 1:1. Since the training data are adjusted to 1:1 through oversampling, the attack and normal ratio in each of the mini-batches in FIG. 4 is also adjusted to 1:1.

Here, filling deficient data with existing training data is oversampling. For example, if there are 6 (six) attack data and 3 (three) normal data, an operation of fetching 3 normal data somewhere so as to set the attack/normal ratio to 1:1 is oversampling. In the case of MCBN, 3 normal data can be obtained from the training data.

Here, adjusting the attack/normal ratio to 1:1 has a following meaning. That is, in the example of FIG. 4, it is a situation that there is one test data but it is not known whether the test data is attack or normal data. In this case, the training data consists of 6 attack data and 3 normal data. By copying 3 normal data of the training data, 6 attack test data and 6 normal test data can be obtained. The mini-batch consists of one test data, 6 attack training data and 6 normal training data. Thereby, the attack/normal ratio is 7:6 or 6:7, which is “substantially” 1:1.

In this case, when judging one test data, since three training data for which it is not necessary to perform judgment are included, an amount of computation is larger than the method shown in FIG. 3 by the test data. That is, as compared to the method of FIG. 3, the amount of computation in the method of using MCBN is increased by a mini-batch size×number of times of repeating judgment. Here, in the example of FIG. 4, the number of times of repeating judgment may be 3.

Since the dropout of the neutral network is different each time another mini-batch set is tested and the training data configured together with the given test data is also different, a batch normalization value is also different. That is, the structure of the neutral network is different.

Due to this, the judgment probability value changes each time the same test data is repeatedly judged three times. Here, the description “the judgment probability value changes each time the same test data is repeatedly judged (a total of three times)” means that the judgment is repeatedly performed three times for the test data 1 in the mini-batch set 1, the mini-batch set 2 and the mini-batch set 3, the judgment is also repeatedly performed three times for the test data 2 and the judgment is also repeatedly performed three times for the test data 3, for example.

Then, the reliability can be computed using an average value of the judgment probability values as described above.

Subsequently, the method of judging reliability of a deep learning machine in accordance with the present invention is described.

First, it is arbitrarily judged by the deep learning machine 20 when the test data is attack data or normal data. In the example of FIG. 5, a total of 10 test data consisting of 6 attack data and 4 normal data are arbitrarily judged.

In this case, in order to adjust the attack/normal ratio to 1:1, 2 normal data are obtained from data trained by the deep learning machine.

Then, a mini-batch is configured by the test data whose attack/normal ratio is adjusted to 1:1.

Then, mini-batch sets using all the test data are tested.

Since the mini-batch is configured by the test data as many as possible, an amount of computation corresponding to the minimum number of times of repeating judgment is more required than the existing method. That is, in the present invention, an amount of computation corresponding to the maximum number of times of repeating judgment×2 is required. Additionally, since the mini-batch is configured by the test data as many as possible, an amount of computation corresponding to at least the number of times of repeating judgment may be more required than the existing method.

Since the dropout of the neutral network is different each time another mini-batch set is tested and the training data configured together with the given test data is also different, a batch normalization value is also different. That is, the structure of the neutral network is different.

Due to this, the judgment probability value changes each time the same test data is repeatedly judged three times.

Then, the reliability can be computed using an average value of the judgment probability values as described above.

In the meantime, the reason that the reliability of judgment in the present invention is similar to the MCBN method is because the same data are tested more than once in neutral networks of different structures and an average value of the judgment probability values is then obtained, like the MCBN method.

In the below, the computation complexities in the conventional methods (FIGS. 3 and 4) and the method of judging reliability of a deep learning machine in accordance with the present invention are compared.

First, in the existing method shown in FIG. 3, the judgment is performed only once. However, it is difficult to judge the reliability in the existing method shown in FIG. 3.

Next, in the method of judging reliability of a deep learning machine using the MCBN method shown in FIG. 4, an amount of computation corresponding to [an amount of existing computation (1)×the number of times of repeating judgment (T)×the number of test data (M)] is required. Here, T refers to the number of mini-batch sets, and M may refer to the number of test data configuring a mini-batch.

Next, in the method of judging reliability of a deep learning machine in accordance with the present invention (refer to FIG. 5), while the reliability similar to the reliability obtained in the MCBN method is obtained, a smaller amount of computation than the amount of computation in the MCBN method can be used.

First, if the attack/normal ratio of the test data is the same, an amount of computation corresponding to [an amount of existing computation (1)×the number of times of repeating judgment (T)] can be used. In this case, oversampling is not required.

Second, if the attack/normal ratio of the test data is 1:0, an amount of computation corresponding to [an amount of existing computation (1)×the number of times of repeating judgment×2] can be used. In this case, since oversampling corresponding to the attack data is required, the amount of computation may be doubled.

That is, the amount of computation of the present invention ([an amount of existing computation(1)×the number of times of repeating judgment (T)] or [an amount of existing computation(1)×the number of times of repeating judgment×2]) is larger than the amount of computation in the existing method shown in FIG. 3 but may be M/2 times to M times smaller than the amount of computation in the MCBN method of FIG. 4 ([an amount of existing computation (1)×the number of times of repeating judgment (T)×the number of test data (M)]).

The reason is that only one test data is included in one mini-batch in the MCBN method. That is, assuming that a size of one mini-batch is 4, in the case of MCBN, if there are 12 test data before oversampling, a mini-batch set is configured by 12 mini-batches after oversampling, so that a total of 48 data should be judged in the end. However, according to the present invention, if there are 12 test data before oversampling and the attack/normal ratio is 1:1, oversampling is not required. Therefore, a mini-batch set can be configured by three mini-batches, so that 12 data can be judged in the end.

As another example, in a case where the test data (M) is 100, a size of the mini-batch is 10 and the number of times of repeating judgment (T) is 5, the amount of computation in the existing method shown in FIG. 3 is [100/10=10] (a total of 10 mini-batches are tested),

the amount of computation in the MCBN shown in FIG. 4 is [((100/10)×(100))×5 =5000], and

the amount of computation in the method of the present invention shown in FIG. 5 is:

i) [(100/10)×5=50], when the attack/normal ratio of the test data before oversampling is the same, and

ii) [((100/10)×(2))×5=100], when the attack/normal ratio of the test data before oversampling is 1:0.

Therefore, according to the present invention, the reliability that is higher than the existing method shown in FIG. 3 and is similar to the MCBN method shown in FIG. 4 can be obtained. Although the larger amount of computation than the existing method shown in FIG. 3 is required, the smaller amount of computation than the amount of computation in the MCBN method shown in FIG. 4 can be required.

As a result, according to the present invention, it is possible to secure the higher reliability and the smaller amount of computation.

Subsequently, the method of judging reliability of a deep learning machine in accordance with the present invention is described step by step.

First, the process of configuring the N mini-batches by using the M test data for which it has been determined whether the data is normal or attack, and configuring a mini-batch set including the N mini-batches is repeated T times. In the example of FIG. 5, M is 12 and N is 3. That is, in the example of FIG. 5, the three mini-batches are configured using the 12 test data, and the three mini-batches configure one mini-batch set. The step of repeating T times the process of configuring the mini-batch set includes a step of configuring N mini-batches by using the M test data for which it has been determined whether the data is normal or attack and configuring a first mini-batch set including the N mini-batches, and a step of configuring N mini-batches having a combination, which is different from a combination of the N mini-batches configuring the first mini-batch set, by using the M test data and configuring a T^{th} mini-batch set including the N mini-batches.

That is, in the example shown in FIG. 5, T is 3. Therefore, the three mini-batch sets are formed.

In this case, the M test data that are used in each of the T mini-batch sets are the same.

That is, in the example shown in FIG. 5, the 12 test data that are used for the first mini-batch set (mini-batch set 1), the 12 test data that are used for the second mini-batch sets (mini-batch set 2), and the 12 test data that are used for the third mini-batch set (mini-batch set 3) are all the same.

However, the combination of the M/N test data is different for each of the mini-batches.

That is, in the example shown in FIG. 5, the combinations of the four test data configuring each of the 9 mini-batches included in the three mini-batch sets are different from each other in the 9 mini-batches. For example, the first mini-batch (mini-batch 1) configuring the first mini-batch set (mini-batch set 1) consists of the test data of ‘1, 2, 7 and 8’, the second mini-batch (mini-batch 2) consists of the test data of ‘3, 4, 9 and 10’, and the third mini-batch (mini-batch 3) consists of the test data of ‘5, 6, 11 and 12’.

Also, the attack/normal ratio of the M/N test data included in each of the N mini-batches is adjusted to 1:1 or to a ratio close to 1:1.

For example, in the example shown in FIG. 5, in each of the three mini-batches configuring the first mini-batch set, a ratio of attack test data and normal test data is set to 2:2=1:1.

Also, some data of the M test data can be obtained from the training data so as to adjust the attack/normal ratio to 1:1.

For example, in the example shown in FIG. 5, two (11 and 12) of the 12 test data configuring the first mini-batch set are the training data. However, the present invention is not limited thereto. Therefore, the training data may not be included in the M test data.

Then, a process of judging the M/N test data included in each of the N mini-batches configuring any one mini-batch set to judge the attack/normal ratio of each of the N mini-batches is performed for a total of the T mini-batch sets.

That is, the M/N test data included in each of the N mini-batches configuring the first mini-batch sets are judged to judge the attack/normal ratio of each of the N mini-batches configuring the first mini-batch set, the M/N test data included in each of the N mini-batches configuring the second mini-batch sets are judged to judge the attack/normal ratio of each of the N mini-batches configuring the second mini-batch set, and the M/N test data included in each of the N mini-batches configuring the T^{th} mini-batch set are judged to judge the attack/normal ratio of each of the N mini-batches configuring the T^{th} mini-batch set.

Finally, when an average of the T attack/normal ratios for each of the N mini-batches is greater than 0.7 and smaller than 1.3, the judgment is judged as reliable, and when an average of the T attack/normal ratios for each of the N mini-batches is equal to or smaller than 0.7 or equal to or greater than 1.3, the judgment is judged as not reliable.

That is, according to the present invention, when the average of the T attack/normal ratios is close to 1, the judgment is judged as reliable, and when the average of the T attack/normal ratios is close to 0.5 or 0 or is infinite, the judgment is judged as not reliable.

For example, in the example shown in FIG. 5, when an average of the attack/normal ratio in the first mini-batch included in the first mini-batch set, the attack/normal ratio in the first mini-batch included in the second mini-batch set and the attack/normal ratio in the first mini-batch included in the third mini-batch set is close to 1, the judgment can be judged as reliable.

Alternatively, in the example shown in FIG. 5, when an average of the attack/normal ratios in the three mini-batches included in the first mini-batch set, the attack/normal ratios in the three mini-batches included in the second mini-batch set and the attack/normal ratios in the three mini-batches included in the third mini-batch set is close to 1, the judgment can be judged as reliable.

The differences between the present invention and the existing MCBN method are described.

The running process of the MCBN is as follows. Usually, the training process is progressed with the attack/normal ratio being kept as 1:1.

If a specific label (normal or attack) is abnormally low, the corresponding label is oversampled to keep the ratio at 1:1 and the training is progressed.

At this time, the training is progressed with batch normalization and dropout being activated.

In general, when the training is over, batch normalization (BN) and dropout are inactivated and evaluation data (or judgment data) is input to judge whether the corresponding data is attack or normal.

In a case of MCBN, when the number (M) of the test data is 16, a mini-batch is configured by one judgment data and 15 training data (oversampling is made so that the attack/normal ratio of the test data is 1:1).

In this case, the judgment is performed T times with batch normalization (BN) and dropout being activated.

In this case, since another training data and another dropout are used each time the judgment is performed, a result value of the corresponding judgment data changes.

When averaging the values, it is expected that a judgment result of the corresponding judgment data is more stable, which is a characteristic of the MCBN.

However, the MCBN has a problem that an M×T times larger amount of computation as compared to the normal judgment method is required to judge one judgment data.

The reason is that (M-1) training data, for which it is not necessary to perform judgment, are required to configure a mini-batch and the judgment should be repeated T times.

On the other hand, according to the present invention, the attack/normal ratio of judgment data is judged using the usual judgment method.

First, it is checked which label is deficient based on a judged label, and the deficient label is fetched from the training data.

For example, when data judged as an attack label is too small, the training data of the corresponding label is fetched to adjust the ratio to 1:1. For example, in the example shown in FIG. 5, two (11 and 12) of the 12 test data are the training data.

In this case, as described above, according to the present invention, only a half amount of computation as compared to MCBN is required in extreme cases.

In an ideal case, i.e., in a case where a ratio of attack label and normal label is 1:1, the amount of computation is reduced to 1/M, as compared to MCBN.

The reason is that since the attack/normal ratio is already kept as 1:1, it is not necessary to fetch data from the training data, so that the judgment can be repeated just T times.

One skilled in the art relating to the present invention can understand that the present invention can be implemented in other specific forms without changing the technical spirit or essential features thereof. Therefore, the above embodiments should be construed in all respects as exemplary not restrictive. The scope of the present invention being indicated by the claims rather than by the foregoing description and all changes or modifications which come within the meaning and the range of equivalency of the claims are therefore intended to be embraced therein.

1. A method of judging reliability of a deep learning machine comprising:
the deep learning machine configuring N mini-batches, in which an attack/normal ratio is adjusted to 1:1 through oversampling from training data for data of class judged as being smaller as to attack or normal, by using M test data judged as to a class as normal or attack, and
configuring T mini-batch sets each including the N mini-batches; and
the deep learning machine iteratively performing multiple times a process of judging the test data provided for each of the N mini-batches configuring the mini-batch sets to judge an attack/normal ratio of each of the N mini-batches,
wherein the M test data that are used for each of the T mini-batch sets are the same but combinations of the test data of each of the mini-batches are different for each of the mini-batches and a size of each of the mini-batches is M/N, where M, N and T are each an integer of 2 or larger, M is the number of the test data, N is the number of the mini-batches and T is the number of the mini-batch sets,
wherein the class indicates that data is classified as attack or normal, and
wherein reliability of the judgment is judged depending on a degree that an average value of attack/normal ratios obtained as a result of iteratively performing the multiple times the judgment for each of the N mini-batches is close to 1.

2. The method according to claim 1, wherein the multiple times is a number that is the same as the number T of the mini-batch sets.

3-5. (canceled)
